(19) United States
(12) Patent Application Publication
(10) Pub. No.: US 2017/0280714 A1
(43) Pub. Date: Oct. 5, 2017

(54) Compositions for and Methods of Attracting the Small Hive Beetle Aethina tumida

(71) Applicant: The United States of America, as Represented by the Secretary of Agriculture, Washington, DC (US)

(72) Inventors: Charles J. Stuhl, Gainesville, FL (US); Peter E. Teal, Gainesville, FL (US)

(21) Appl. No.: 15/459,704

(22) Filed: Mar. 15, 2017

Related U.S. Application Data
(60) Provisional application No. 62/314,639, filed on Mar. 29, 2016.

(51) Int. Cl. A01N 31/02; A01N 25/02; A01N 25/08; A01N 27/00

(52) U.S. Cl. CPC A01N 31/02; A01N 27/00; A01N 25/02; A01N 25/08

(57) ABSTRACT

Compositions containing 6-methyl-5-hepten-2-one, nonanal and decanal. Methods of attracting the small hive beetle Aethina tumida, involving treating an object or area with a small hive beetle Aethina tumida attracting effective amount of a composition containing 6-methyl-5-hepten-2-one, nonanal and decanal, and optionally a carrier. The composition does not contain any other compound produced by the small hive beetle Aethina tumida other than 6-methyl-5-hepten-2-one, nonanal and decanal.

### REFERENCE TO RELATED APPLICATION

This application claims the benefit of U.S. Provisional Application No. 62/314,639, filed 29 Mar. 2016, which is incorporated herein by reference in its entirety.

### BACKGROUND OF THE INVENTION

Disclosed are compositions containing 6-methyl-5-hepten-2-one, nonanal and decanal. Also disclosed are methods of attracting the small hive beetle (SHB) Aethina tumida, involving treating an object or area with a small hive beetle Aethina tumida attracting effective amount of a composition containing 6-methyl-5-hepten-2-one, nonanal and decanal, and optionally a carrier.

The honeybee, Apis mellifera, is a vital component of modern agriculture. Currently there are more than 2.5 million honeybee producing colonies in the United States, with an estimated value of the beekeeping and pollination industries of about 14.6 billion dollars per year. The loss of managed honey bee colonies in the winter of 2014-2015 was 23.1%. Results of the 2015-2016 annual survey conducted by the Bee Informed Partnership indicated an annual loss of 44% (Steinhauer, N., et al., 2015, Colony Loss 2014-2015: Preliminary Results, https://beeinformed.org/results/colony-loss-2014-2015-preliminary-results).

Honeybees are highly efficient foragers on numerous flowering plants, including agricultural crops. Plant pollination by the honeybee is the most commonly recognized means of crop pollination. Beekeepers are challenged with disease and pests within hives such as the small hive beetle and varroa mite.

The small hive beetle is an opportunistic pest that will take advantage of a weak or stressed hive. If the beetle infestation is high, the bees will abandon their hive (Elzen, P. J, and P. Neumann, Apidologie 35: 229-247 (2004)). The rapid spread of this pest and its impact on the honey bee population has warranted an effective trapping system to control its impact on pollination, honey production, and honey bee survival.

Aethina tumida originated in sub-Saharan Africa, where it is considered a minor honey bee pest. Its presence was confirmed in a commercial apiary in Florida in 1998, although previously unidentified specimens indicate its presence in the U.S. since 1996. They have been a pest on the Australian continent since 2000 (Ellis, J. D., and H. R. Hepburn, Insectes Sociaux, 53: 8-19 (2006)). Adult beetles and larvae feed on honey, pollen and bee brood (Hepburn, H. R., and S. Radloff, Honeybees of Africa, 1998, Springer Verlag, Berlin, Germany). Females, capable of producing 2000 eggs in her lifetime, place their eggs onto honey, pollen stores, and brood and deposit them in crevices or cavities away from the bees to avoid removal (Hood, W. M., Bee World, 85: 51-59 (2004)). Larval feeding on the hive is the most destructive stage in the SHB lifecycle. Near the end of the larval stage, larvae leave the hive and pupate in the soil. Upon eclosion, adults emerge from the soil and seek refuge in honey bee hives. A small hive beetle population can grow exponentially within a short amount of time. It has been shown that less than 100 small hive beetles can become more than 36,000 adults in ˜2 months. Larvae cause severe damage to honey bee colonies resulting in the colony collapsing. They cause the most destruction by consuming honey bee eggs, brood, pollen, and honey. Adults and larvae infect honey and pollen stores with yeast that causes the honey to ferment, froth and leak out from the cells, rendering the honey unsuitable for consumption. When the larval population reaches a certain point, the queen will stop egg laying and the colony will leave from the hive. Weak and queenless hives are considered to be more susceptible to small hive beetle damage than strong healthy colonies. However, all colonies are susceptible to damage when large numbers of beetles are present. Currently, there is no effective trapping system employed to monitor or control beetle populations outside of the hive. There are several in-hive trapping devices to control small hive beetles and most of these beetle traps use either vegetable or mineral oil as the trapping/killing agent.

Pollinators are critical to our Nation's economy, food security, and environmental health. Honey bee pollination adds more than $15 billion in value to agricultural crops each year, and provides a foundation to ensure our diets are plentiful with fruits, nuts, and vegetables. Beekeeping management costs throughout the United States have increased due to the damaging effects caused by this pest. The costs include (1) time and labor for beetle detection and treatment and materials; (2) the replacement of honeybee colonies due to beetle loss; (3) damaged equipment replacement; (4) loss in honey, wax, pollen production; and (5) reduction in the abundance of insects available for pollination of economically important crops.

We have found that three chemicals (6-methyl-5-hepten-2-one, nonanal and decanal) surprisingly mimic the aggregation pheromone of the small hive beetle, and can be used in the control of this pest.

### SUMMARY OF THE INVENTION

Disclosed are compositions containing 6-methyl-5-hepten-2-one, nonanal and decanal. Also disclosed are methods of attracting the small hive beetle Aethina tumida, involving treating an object or area with a small hive beetle Aethina tumida attracting effective amount of a composition containing 6-methyl-5-hepten-2-one, nonanal and decanal, and optionally a carrier.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows the gas chromatography and mass spectrometry (GC-MS) chromatogram of the small hive beetle pheromone as described below.

FIG. 2 shows the GC-MS chromatogram of the small hive beetle synthetic pheromone blend as described below.

FIG. 3 shows semiochemical response of small hive beetles to a synthetic blend of chemicals that mimic the male produced aggregation pheromone as described below. Those sharing a letter are not significantly different. The aggregation synthetic blend was 99%, blank control >1%, no response >1% (n=3641, p>0.001).

### DETAILED DESCRIPTION OF THE INVENTION

We have discovered and subsequently isolated and synthesized small hive beetle aggregation pheromone which surprisingly serves as an effective attractant for beetles. Disclosed are compositions containing 6-methyl-5-hepten-2-one, nonanal and decanal. Generally the composition does not contain any other compound produced by the small hive beetle Aethina tumida other than 6-methyl-5-hepten-2-one, nonanal and decanal. Also disclosed are methods of attracting the small hive beetle Aethina tumida, involving treating an object or area with a small hive beetle Aethina tumida attracting effective amount of a composition containing 6-methyl-5-hepten-2-one, nonanal and decanal, and optionally a carrier; generally the composition does not contain any other compound produced by the small hive beetle Aethina tumida other than 6-methyl-5-hepten-2-one, nonanal and decanal.

The compounds described herein (useful, for example, in attracting Aethina tumida) may be applied with a carrier component or carrier (e.g., agronomically or physiologically or pharmaceutically acceptable carrier). The carrier component can be a liquid or a solid material. As is known in the art, the vehicle or carrier to be used refers to a substrate such as a membrane, hollow fiber, microcapsule, cigarette filter, gel, polymers, bag, vial, septa, or the like. All of these substrates have been used to release volatile chemicals in general and are well known in the art. Suitable carriers are well-known in the art and are selected in accordance with the ultimate application of interest. Agronomically acceptable substances include aqueous solutions, oils, glycols, alcohols, ketones, esters, hydrocarbons, halogenated hydrocarbons, polyvinyl chloride; in addition, solid carriers such as clays, cellulosic, fibers, and rubber materials and synthetic polymers. Suitable carriers are to be selected in accordance with the best application for the release of the pheromone. Acceptable substances are of particular interest that does not pose any threat to honeybees or non-target insects. Polyvinyl chloride is a carrier of interest, in addition, solid carriers such as clays, cellulosic and rubber materials and synthetic polymers. The carrier or carrier material as used herein is defined as not including the body of an insect (e.g., Aethina tumida).

The amount of the composition for attracting Aethina tumida used will be at least an effective amount (i.e., 1 mg or more). The term “effective amount,” as used herein, means the minimum amount of the composition needed to attract Aethina tumida to a treated area or object or locus when compared to the same area or object or locus which is untreated. Of course, the precise amount needed will vary in accordance with the particular composition used; the type of area or object to be treated; the number of days of attractiveness needed; and the environment in which the area or object or locus is located. The precise amount of the composition can easily be determined by one skilled in the art given the teaching of this application. For example, one skilled in the art could follow the procedures utilized below; the composition would be statistically significant in comparison to a control (e.g., water). Generally, the concentrations of synthetic chemicals discussed herein on polypropylene flex tube or plastic bag would range from about 10 mg to about 250 mg (e.g., 10 to 250 mg), monitoring traps would generally use about 50 mg while attract and kill may use about 250 mg, and release rates could generally be about 0.05 to about 30 mg (e.g., 0.05 to 30 mg) per tube/bag per day.

The compositions described herein may or may not contain a control agent for Aethina tumida, such as a biological control agent or an insecticide known in the art to kill Aethina tumida. Other compounds may be added to the composition provided they do not substantially interfere with the intended activity of the composition; whether or not a compound interferes with attractant activity can be determined, for example, by the procedures utilized below.

“Optional” or “optionally” means that the subsequently described event or circumstance may or may not occur, and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

Unless defined otherwise, all technical and scientific terms used herein have the same meaning as commonly understood by one of ordinary skill in the art to which the invention belongs. As used herein, the term “about” refers to a quantity, level, value or amount that varies by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Initial experiments were carried out to isolate pheromone from small hive beetles by volatile collection techniques. Pheromone was collected from small hive beetles laboratory colonies maintained in Gainesville, Fla. Volatiles were collected from 100 adult males and 100 females ˜1 week after emergence. All small hive beetle related collections were performed at the USDA-ARS, Center for Medical, Agricultural and Veterinary Entomology, Gainesville, Fla. (CMAVE).

Isolation of Small Hive Beetle Aggregation Pheromone: Volatiles were collected using a head space collection technique (Heath, R. R., and A. Manukian, Journal of Chemical Ecology, 14: 441-453 (1992)). This technique was used for volatiles collected from male and female beetles. Insects were placed in a glass volatile collection chamber (34 cm long and 4 cm outside diameter) with a glass frit inlet and a glass joint outlet and a single port collector base. The collection chamber was covered with a dark cloth and insects allowed to aggregate for 1 h before each collection. Dry charcoal filtered air was pushed into one end of the chamber and over the beetles and exited the chamber via a vacuum system. The air then passed through a volatile collection filter containing 50 mg of Tenex® Porous Polymer Adsorbent (Sigma-Aldrich, USA) for 5 minutes. There were 5 replicates for each sex. Extracts were subsequently analyzed by gas chromatography and mass spectrometry (GC-MS). Comparison of extracts from males and from females revealed that males produced three compounds in much greater amounts than detected from females. GC-EAD recordings using antennae from males and females demonstrated that the insects were especially sensitive to the three male-specific compounds.

Chemical Analysis and Pheromone Identification: The volatile compounds collected were analyzed by GC-Mass Spectrometry (GC-MS) (GC: Agilent 6890 with an HP-5MS capillary column of 30 m long, 0.25 mm inner diameter, and 0.25-μm film thickness; MS: Agilent 5973 mass selective detector, 70 eV, equipped with a thermal desorption cold trap injector (TCT) (CP4010; Chrompack, Bergen op Zoom, The Netherlands)). Headspace volatiles collected on Tenax TA were released from the adsorbent by heating in the TCT at 220° C. for 8 min within a flow of helium gas. The desorbed compounds were collected in the TCT cold trap unit (SIL5CB-coated fused silica capillary) at −130° C. Flash heating of the cold trap unit injected the compounds into the capillary column of the gas chromatograph to which the cold trap unit was connected. The oven temperature of the GC was programmed to rise from 40° C. (5-min hold) to 280° C. at 15° C./min. The headspace volatiles were identified by comparing their mass spectra to those of the database (Wiley7N and Wiley275) and by comparing their retention times to those of authentic compounds.

### Behavioral Testing: Example 1. Attraction of Small Hive Beetle to a Baited Trap

Trapping assays were performed in a climate-controlled chamber at 23±5° C., 60% RH, and photoperiod of 12:12 (L:D) h. An inverted Rescue Reusable Stink bug trap (Sterling International, Inc., Spokane, Wash.) was used in the assay. The trap was inverted to allow the entrance to face upright. Two traps, a treatment and a blank control (ethanol), were suspended from the ceiling of the enclosure. The attractant blend was delivered via an impregnated cotton dental wick cut to length and place inside a 1 ml Eppendorf® tube (Sigma-Aldrich, USA). The tube was then attached to the inside chamber of the trap. A blank control was run alongside the treatment. A rearing box containing (˜400) newly emerged SHB adults were opened inside a screen mesh cylindrical field cage (91.5 c diam.×183 c height). The assay was run for 24 h after which the trapped insects were counted.

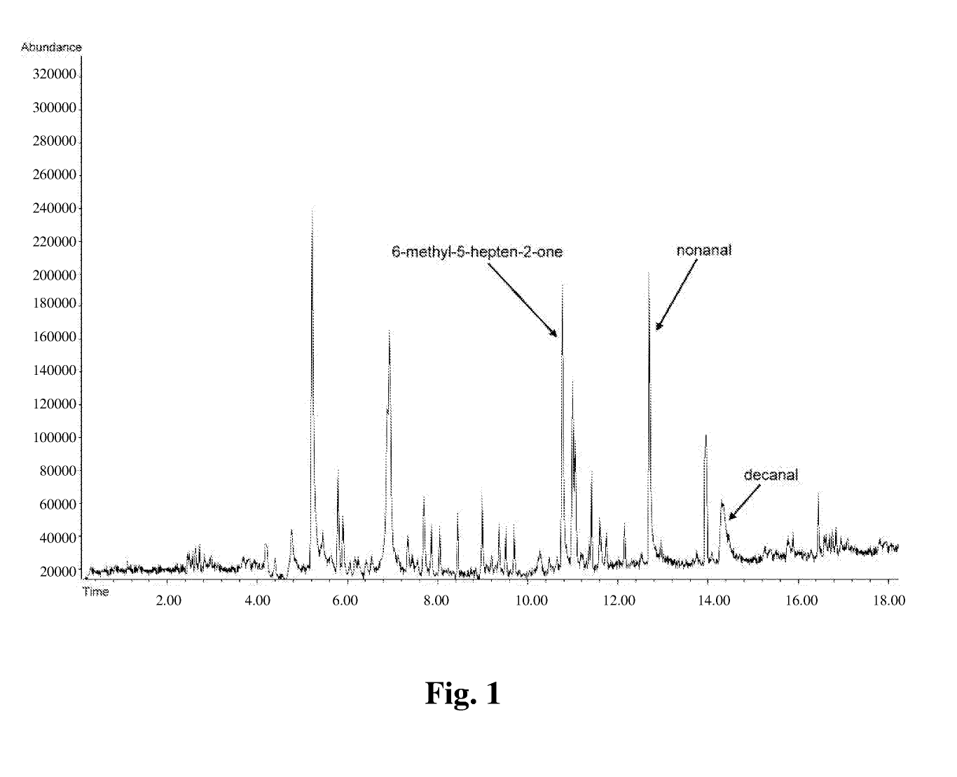

Results. Identification of Aggregation Pheromone: Three components were isolated from male SHB. The most abundant component was 6-methyl-5-hepten-2-one and two minor components, nonanal and decanal (FIG. 1). The identical compounds were also isolated from SHB females, but in a very small amount compared to what were being produced by the males.

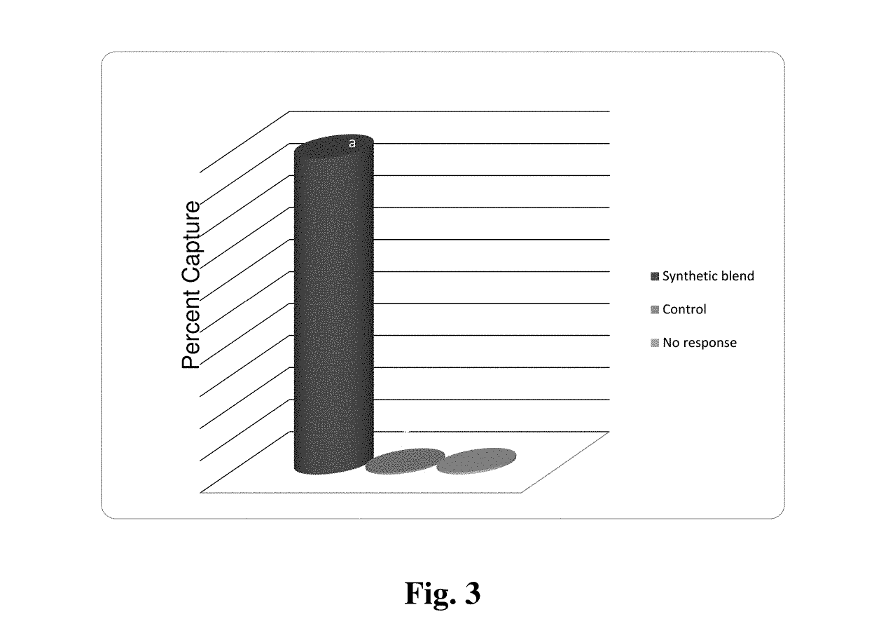

Trapping Bioassay: This experiment demonstrated the attraction to the synthetic aggregation pheromone. A significantly higher percentage of insects were captured in a reusable trapping device; the synthetic blend surprisingly captured 99%, the control >1% and those that did not respond were >1% (n=3641, p>0.001) of beetles were captured in traps baited with the 6-methyl-5-hepten-2-one, nonanal and decanal blend than the traps containing a blank control (FIG. 3).

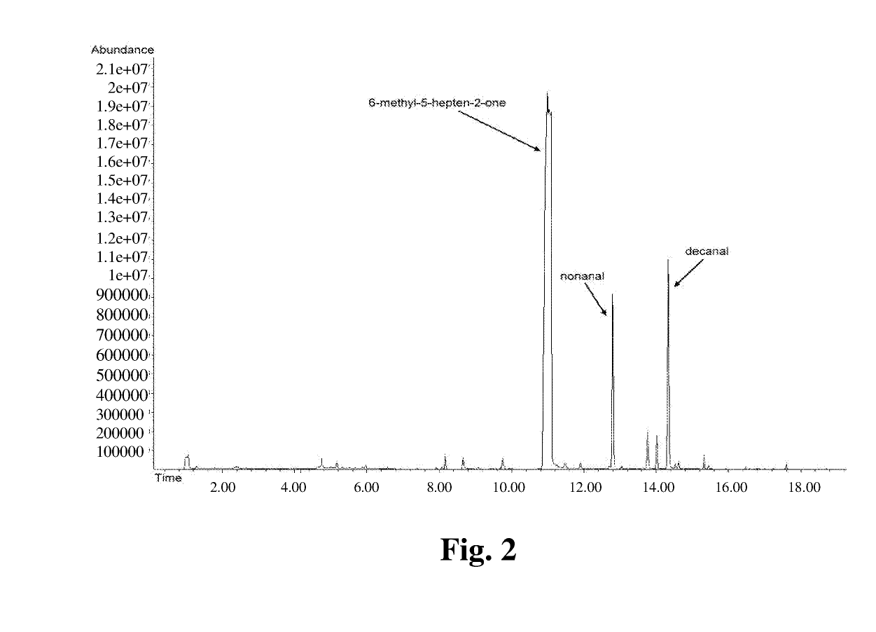

Discussion: This study demonstrated that a blend of three compounds isolated from SHB surprisingly induced a high level of attraction. GC-MS analyses, and confirmation with internal standards, identified the aggregation blend as containing 6-methyl-5-hepten-2-one, nonanal and decanal (FIG. 1). These compounds have never been described as being associated with SHB. The pheromone was isolated from male SHB and was surprisingly found to be highly attractive to both sexes. A highly attractive synthetic blend was formulated that surprisingly mimicked the SHB aggregation pheromone (FIG. 2).

Trap captures indicated that the male produced aggregation pheromone was detected and produced a behavioral response in both sexes of adult beetles. Surprisingly, they displayed a strong attraction to the pheromone blend, which induced aggregation once collected in the trap. The effectiveness of this discovery was surprisingly enhanced by its capability to capture both male and female beetles. The availability of a tool to reduce both sexes from the environment has a great advantage over a single-sex targeted strategy. The removal of a single female reduces the possibility of her ability to produce as many as 2000 beetles over her lifetime.

It is not possible to control this pest within a hive by means of an insecticide. A baited trap that that is directed at the SHB and restricts honey bee access is the only way to target this pest within and outside of the hive. This method has been successfully demonstrated for monitoring and the reduction of nitidulid beetle populations (Lin et al. 1992).

Results of this study suggest an effective use of a synthetic aggregation pheromone as a monitoring and control measure for SHB. The components of this attractant were surprisingly highly attractive and extremely successful in trapping the small hive beetle. Surveying and monitoring with insect pheromones has become a widely used practice worldwide against pest insect species. These types of systems have become an integral part of many agricultural management programs. This discovery has the potential to control an invasive species that is effecting honey bee survival worldwide.

All of the references cited herein, including U.S. Patents and U.S. Patent Application Publications, are incorporated by reference in their entirety.

Thus, in view of the above, there is described (in part) the following:

A composition (for attracting the small hive beetle Aethina tumida) comprising (or consisting essentially of or consisting of) 6-methyl-5-hepten-2-one, nonanal and decanal. Wherein said composition does not contain any other compound produced by the small hive beetle Aethina tumida other than 6-methyl-5-hepten-2-one, nonanal and decanal.

An aggregation pheromone attractant for trapping small hive beetle comprising (or consisting essentially of or consisting of) the following components: 6-methyl-5-hepten-2-one, nonanal and decanal. Wherein said attractant does not contain any other compound (e.g., ester of acetic acid) produced by the small hive beetle Aethina tumida other than 6-methyl-5-hepten-2-one, nonanal and decanal.

A method of attracting the small hive beetle Aethina tumida, said method comprising (or consisting essentially of or consisting of) treating an object or area with a small hive beetle Aethina tumida attracting effective amount of a composition comprising (or consisting essentially of or consisting of) 6-methyl-5-hepten-2-one, nonanal and decanal, and optionally a carrier. Wherein said composition does not contain any other compound produced by the small hive beetle Aethina tumida other than 6-methyl-5-hepten-2-one, nonanal and decanal. The method above, wherein both males and females are attracted.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element (e.g., method (or process) steps or composition components) which is not specifically disclosed herein.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

We claim:

1. A composition comprising 6-methyl-5-hepten-2-one, nonanal and decanal.

2. The composition according to claim 1, wherein said composition does not contain any other compound produced by the small hive beetle Aethina tumida other than 6-methyl-5-hepten-2-one, nonanal and decanal.

3. A method of attracting the small hive beetle Aethina tumida, said method comprising treating an object or area with a small hive beetle Aethina tumida attracting effective amount of a composition comprising 6-methyl-5-hepten-2-one, nonanal and decanal, and optionally a carrier.

4. The method according to claim 3, wherein said composition does not contain any other compound produced by the small hive beetle Aethina tumida other than 6-methyl-5-hepten-2-one, nonanal and decanal.

5. The method according to claim 3, wherein both males and females are attracted.
